(19) United States
(12) Patent Application Publication
(10) Pub. No.: US 2024/0295216 A1
(43) Pub. Date: Sep. 5, 2024

(54) Reciprocal Pump Injector System

(71) Applicant: Timothy Nelson, Richmond, CA (US)

(72) Inventor: Timothy Nelson, Richmond, CA (US)

(21) Appl. No.: 18/116,540

(22) Filed: Mar. 2, 2023

(51) Int. Cl. F04B 53/10; A22C 17/00; F04B 9/14; F04B 19/22

(52) U.S. Cl. CPC F04B 53/1002; A22C 17/0053; F04B 9/14; F04B 19/22

(57) ABSTRACT

A reciprocal pump injector having a hollow cylinder with a hollow piston rod slideably retained within the hollow cylinder. A hollow handle is formed at a top end of the hollow piston rod. A piston is attached at a bottom end of the hollow piston rod. An upper ball valve is formed at a top end of the hollow piston rod and a lower ball valve formed at a top end of a suction tube attached to a bottom end of the hollow cylinder. A hollow spout extends from the hollow handle and a hose extends from the spout. A hollow needle having a closed sharp tip is attached to the free end of the hose and the shaft of the needle has two to six openings along the shaft of the hollow needle. The pump injector system allows injection of particulate seasoning, such as pepper and garlic, as well as liquid seasoning, through the plurality of openings in the needle and into the meat.

### FIELD OF USE

This invention relates to reciprocal injector pumps and, more particularly, to a reciprocal pump that operates with ball valves for injection of seasoning into meat products.

### BACKGROUND OF THE INVENTION

Needle injectors are used by restaurants and customers of food businesses to inject prepared flavoring. Prior art pumps inject liquids easily but have difficulty dispensing liquids containing spices such as lemon pepper, granulated garlic, and coarse black pepper because these spices tend to plug the injection needle of the pump. With some of these pumps, the cylinder needs to be refilled after every injection by drawing liquids from a bowl through the needle of the pump. Also, liquids in the bowl need to be stirred to keep spices from settling. U.S. Patent Application No. 2008/0168909 discloses a manual reciprocal pump with a syringe needle for injecting seasoning into meat. The needle for injection has a single hole on the side of the needle near the tip of the needle. This configuration does not allow spices such as lemon pepper, granulated garlic, and coarse black pepper to exit the needle and will clog the needle. What is needed is a manual reciprocal pump that allows liquids with granular spices to be pumped out of the injection needle.

### SUMMARY OF THE INVENTION

This invention is a reciprocal pump injector having a hollow cylinder with a hollow piston rod slideably retained within the hollow cylinder. A hollow handle is formed at a top end of the hollow piston rod. A piston having a central channel is attached at a bottom end of the hollow piston rod. An upper ball valve is formed at a top end of the hollow piston rod and a lower ball valve is formed at a top end of a suction tube attached to a bottom end of the hollow cylinder. A hollow spout extends from the hollow handle and a hose is attached to the spout. A hollow needle is attached reversibly to an opposite end of the hose. The free end of the hollow needle has a sharp pointed tip which is closed. The hollow needle has two to six openings along the shaft of the hollow needle. A spring is positioned in an interior of the hollow cylinder between the piston and the bottom end of the of the hollow cylinder. The spring is constructed to bias the piston towards the top end of the hollow cylinder. The upper ball valve comprises a chamber with an upper ball therein and the lower ball valve comprises a chamber in the upper end of the suction tube with a lower ball therein. A deflector in the interior of the hollow handle prevents the upper ball from entering the hollow spout. The bottom end of the spring has a ball cage to retain the lower ball near the bottom end of the hollow handle.

The reciprocal pump injector may be attached to a container having a cap and a handle. The top end of the hollow cylinder is attached to the underside of the cap and the hollow cylinder and suction tube are inserted into the container. The top end of the hollow piston rod has external threads, and the cap has a coupler with internal threads, wherein the coupler is formed on the top surface of the cap. The external threads at the top end of the piston rod engage the internal threads of the coupler, when the handle of the hollow piston rod is pushed down to the coupler. Rotating the external threads of the of the piston rod into the internal threads of the coupler reversibly lock the handle of the hollow piston rod next to the coupler. The handle of the coupler is used to shake the container while a liquid seasoning composition is injected by the reciprocal pump injector into meat. Shaking the container suspends particulate seasoning in the liquid seasoning composition. The two to six holes on the shaft of the needle allow the passage of the particulate seasoning along with the liquid seasoning.

An advantage of the reciprocal pump injector system of this invention is a reciprocal pump that is simple in construction, durable, and easy to maintain.

Another advantage is the ability of the pump injector system to inject particulate seasoning, such as pepper and garlic through the plurality of openings in the needle and into the meat.

Another advantage is the ability to reversibly lock the piston rod to the cap and the end of injecting to prevent the spring from automatically causing the filling the cylinder.

Another advantage is automatic refilling of the cylinder by action of the spring.

### BRIEF DESCRIPTION OF THE DRAWINGS

FIG. 1 shows a sectional view of a reciprocal pump injector system of this invention.

FIG. 2 shows an enlarged sectional view of the top end of a piston rod and a cap connected to a container having a liquid mixture which is for injection into meat products by means of a cylinder and piston positioned within the container.

### DETAILED DESCRIPTION OF THE INVENTION

While the following description details the preferred embodiments of the present invention, it is to be understood that the invention is not limited in its application to the details of arrangement of the features as disclosed herein or as illustrated in the accompanying figures, since the invention is capable of other embodiments and of being practiced in various ways.

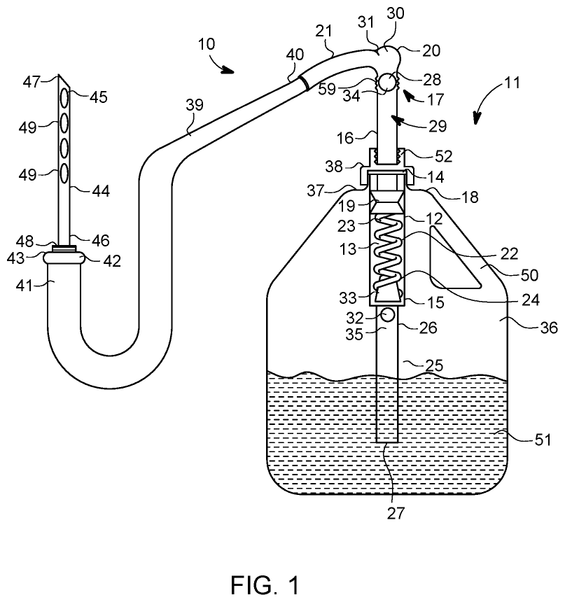

FIG. 1 shows a partially sectional view of a reciprocal pump injector system 10 of this invention. The reciprocal pump 11 has a hollow cylinder 12 (barrel) with an interior 13, a top end 14 and a bottom end 15. A piston rod 16 (plunger) is inserted slidably in the interior 13 of the cylinder 12 and extends out of an opening in the top end 14 of the cylinder 12. The piston rod 16 has a top end 17 and a bottom end 18. A piston 19 is mounted at the bottom end 18 of the piston rod 16 in the interior 13 of the cylinder 12. The top end 17 of the piston rod 16 forms a handle 20. A spout 21 extends from the handle 20. The piston rod 16, the handle 20, and the spout 21 are hollow. The piston 19 has a central opening.

A spring 22 is positioned in the interior 13 of the cylinder 12 between the piston 19 and the bottom end 15 of the of the cylinder 12. The spring 22 biases the piston 19 towards the top end 14 of the cylinder 12. A top end 23 of the spring 22 engages the piston 19 and the bottom end 24 of the spring 22 has a ball cage 33. A hollow suction tube 25, having a top end 26 and bottom end 27, is attached to the bottom end 15 of the cylinder 12. The interior of the hollow suction tube 25 is in communication with the hollow interior 13 of a cylinder 12. An upper ball 28 in an upper ball chamber 34 reversibly closes the hollow piston rod 16 at the top end 17 of the piston rod 16. A deflector 31 in the interior 30 of the handle 20 prevents the upper ball 28 from entering the spout 21. A lower ball 32 in a lower ball chamber 35 reversibly closes the suction tube 25 at the top end 26 of the suction tube 25. The upper ball 28 and the upper ball chamber 34 form an upper ball valve. The lower ball 32 and the lower ball chamber 35 form a lower ball valve.

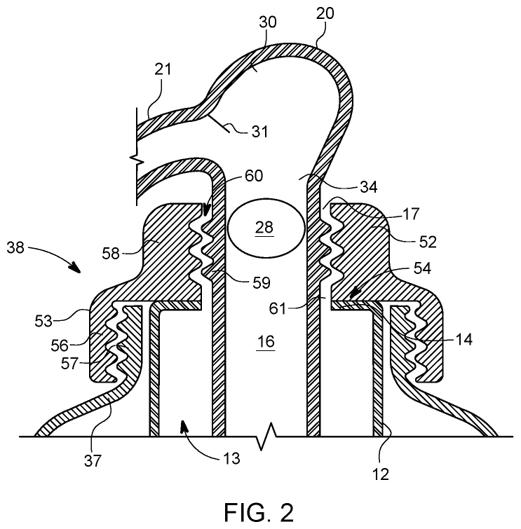

The cylinder 12 and suction tube 25 are positioned in an interior of a container 36, for example a bottle, having a neck portion 37 at the top of the container 36. A cap 38 fits over an opening in the neck 37 of the container 36. The top end 14 of the cylinder 12 is positioned on an interior surface of the cap 38. A coupler 52 having internal threads 58 is formed on the top surface of the cap 38. The piston rod 16 passes through a central opening in the cap 38. The external threads 59 at the top end 17 of the piston rod 16 engage the internal threads 58 (see FIG. 2) of the coupler 52, when the handle 20 is pushed down to the coupler 52, to retain or lock the handle 20 next to the coupler 52.

A hose 39, having a first end 40 and a second end 41, is attached to the spout 21 with the first end 40. The second end 41 can have a coupler with internal threads. A hollow needle 44, having a first pointed, sharp end 45 and a second end 46, is attached to the second end 41 of the hose 39. The needle 44 can be of any desired length, for example, 2 to 12 inches. The needle 44 is closed at the tip 47 and has at least 2 holes 49 in the sides of the needle 44 and can have up to 6 holes. A threaded coupler 48 may be mounted on the second end 46 of the needle 44. The needle 44 may be reversibly attached to the second end 41 of the hose 39 by screwing the threaded coupler 48 into the coupler 42 at the second end 41.

The container 36 has, preferably, a handle 50 and is filled with a liquid flavoring composition 51. The bottom end 27 of the suction tube 25 is placed in the liquid flavoring composition 51.

FIG. 2 shows an enlarged view of the cap 38. The threaded coupler 52 is formed on the top surface 53 of the cap 38. The threaded coupler 52 has a central opening 60 to permit the piston rod 16 to move freely back and forth through the coupler 52, as well as through the opening 61 in the cap 38. The interior surface of the coupler 52 has threads 58 which engage the exterior threads 59 of the piston rod 16. The cap 38 has interior threads 56 which engage external threads 57 on the neck 37 of the container 36. The cap 38 screws onto the neck 37 of the container 36 to retain the cylinder 12 in the interior of the bottle 36.

The reciprocal pump injector system of this invention is used by filling a container with a desired liquid flavoring composition of seasoning, including particulate seasoning. The cylinder and suction tube are inserted into the container through the opening in the neck of the container and attached thereto by screwing a cap onto the neck of the container. The needle is inserted into meat. The piston, positioned at the bottom of the cylinder, is pulled up by pulling the handle at the top of the piston rod upward with a hand of the user or by action of the spring. During this process, the upper ball valve closes as the upper ball goes into the upper ball chamber and the lower ball valve opens as the lower ball comes out of the lower ball chamber and is retained in the ball cage. The liquid in the container is thereby drawn into the suction tube and into the cylinder.

The user pushes the piston down the cylinder by pushing down on the handle of the piston rod with the user's hand. The upper ball valve opens as the upper ball comes out of the upper ball chamber and the lower ball valve closes as the lower ball goes into the lower ball chamber. The liquid in the cylinder is forced out of the cylinder, into the spout, into the tubing, out through the holes in the needle, and into the meat, thereby filling the meat with the liquid flavoring composition, including particulate flavoring in the flavoring composition.

While filling and emptying the cylinder the container is shaken or swirled to mix and suspend the particulate seasoning in the liquid flavoring composition. When the piston rod is pushed all the way down, as shown in FIG. 2, the piston rod can be rotated to screw the top of the piston rod into the threaded coupler on the top of the cap. In this configuration the cylinder is ready to be refilled when a user unscrews the piston rod from the threaded coupler.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, the pump can be operated without a spring. The components of the pump can be made of plastic or metal or a combination thereof. The cylinder can be attached to the container by various methods known in the art. For example, the coupler above the cap may be formed in the top end of the cylinder with internal threads in the top end of the cylinder. The components of the pump can be made of any suitable plastic or metal or a combination thereof.

It will be understood that various changes in the details, materials, and arrangements of the parts which have been described and illustrated above in order to explain the nature of this invention may be made by those skilled in the art without departing from the principle and scope of the invention as recited in the following claims.

I claim:

1. A reciprocal pump injector, comprising:
a) a hollow cylinder having a hollow piston rod slideably retained within the hollow cylinder;
b) a hollow handle formed at a top end of the hollow piston rod;
c) a piston having a central channel attached at a bottom end of the hollow piston rod.
d) an upper ball valve formed at a top end of the hollow piston rod and a lower ball valve formed at a top end of a suction tube attached to a bottom end of the hollow cylinder;
e) a hollow spout having a first end and a second opposite end, the first end of the spout extending from the hollow handle;
f) a hose having a first end and a second opposite end, the first end of the hose attached to the second opposite end of the spout;
g) a hollow needle having a first end and a second opposite end, the first end of the hollow needle having a sharp tip which is closed, and the second opposite end of the needle connected reversibly to the second opposite end of the hose; and
h) the hollow needle having two to six openings between the first end of the hollow needle and the second opposite end of the hollow needle.

2. The reciprocal pump injector of claim 1, further comprising a spring positioned in an interior of the hollow cylinder between the piston and the bottom end of the of the hollow cylinder, the spring constructed to bias the piston towards the top end of the hollow cylinder.

3. The reciprocal pump injector of claim 1, wherein the upper ball valve comprises a chamber with an upper ball therein and the lower ball valve comprises a chamber in the upper end of the suction tube with a lower ball therein, wherein a deflector in the interior of the hollow handle prevents the upper ball from entering the hollow spout, and wherein the bottom end of the spring has a ball cage to retain the lower ball near the bottom end of the hollow handle.

4. The reciprocal pump injector of claim 1, further comprising a container with a cap and a handle, wherein the top end of the hollow cylinder is positioned on the underside of the cap and the hollow cylinder and suction tube are inserted into the container.

5. The reciprocal pump injector of claim 4, further comprising the top end of the hollow piston rod having external threads and the cap having a coupler with internal threads, wherein the coupler is on the top surface of the cap and wherein the external threads at the top end of the piston rod engage the internal threads of the coupler and reversibly lock the handle of the hollow piston rod next to the coupler.

6. A reciprocal pump injector, comprising:
a) a hollow cylinder having a hollow piston rod slideably retained within the hollow cylinder;
b) a hollow handle formed at a top end of the hollow piston rod;
c) a piston having a central channel attached at a bottom end of the hollow piston rod.
d) an upper ball valve formed at a top end of the hollow piston rod and a lower ball valve formed at a top end of a suction tube attached to a bottom end of the hollow cylinder;
e) a hollow spout having a first end and a second opposite end, the first end of the spout extending from the hollow handle;
f) a hose having a first end and a second opposite end, the first end of the hose attached to the second opposite end of the spout;
g) a hollow needle having a first end and a second opposite end, the first end of the hollow needle having a sharp tip which is closed, and the second opposite end of the needle connected reversibly to the second opposite end of the hose;
h) the hollow needle having two to six openings between the first end of the hollow needle and the second opposite end of the hollow needle; and
i) a spring positioned in an interior of the hollow cylinder between the piston and the bottom end of the of the hollow cylinder, the spring constructed to bias the piston towards the top end of the hollow cylinder.

7. The reciprocal pump injector of claim 6, wherein the upper ball valve comprises a chamber with an upper ball therein and the lower ball valve comprises a chamber in the upper end of the suction tube with a lower ball therein, wherein a deflector in the interior of the hollow handle prevents the upper ball from entering the hollow spout, and wherein the bottom end of the spring has a ball cage to retain the lower ball near the bottom end of the hollow handle.

8. The reciprocal pump injector of claim 6, further comprising a container with a cap and a handle, wherein the top end of the hollow cylinder is positioned on the underside of the cap and the hollow cylinder and suction tube are inserted into the container.

9. The reciprocal pump injector of claim 8, further comprising the top end of the hollow piston rod having external threads and the cap having a coupler with internal threads, wherein the coupler is on the top surface of the cap and wherein the external threads at the top end of the piston rod engage the internal threads of the coupler and reversibly lock the handle of the hollow piston rod next to the coupler.

10. A reciprocal pump injector, comprising:
a) a hollow cylinder having a hollow piston rod slideably retained within the hollow cylinder;
b) a hollow handle formed at a top end of the hollow piston rod;
c) a piston having a central channel attached at a bottom end of the hollow piston rod.
d) an upper ball valve formed at a top end of the hollow piston rod and a lower ball valve formed at a top end of a suction tube attached to a bottom end of the hollow cylinder;
e) a hollow spout having a first end and a second opposite end, the first end of the spout extending from the hollow handle;
f) a hose having a first end and a second opposite end, the first end of the hose attached to the second opposite end of the spout;
g) a hollow needle having a first end and a second opposite end, the first end of the hollow needle having a sharp tip which is closed, and the second opposite end of the needle connected reversibly to the second opposite end of the hose;
h) the hollow needle having two to six openings between the first end of the hollow needle and the second opposite end of the hollow needle; and
i) a spring positioned in an interior of the hollow cylinder between the piston and the bottom end of the of the hollow cylinder, the spring constructed to bias the piston towards the top end of the hollow cylinder;
wherein the upper ball valve comprises a chamber with an upper ball therein and the lower ball valve comprises a chamber in the upper end of the suction tube with a lower ball therein,
wherein a deflector in the interior of the hollow handle prevents the upper ball from entering the hollow spout, and
wherein the bottom end of the spring has a ball cage to retain the lower ball near the bottom end of the hollow handle; and
j) a container with a cap and a handle, wherein the top end of the hollow cylinder is positioned on the underside of the cap and the hollow cylinder and suction tube are inserted into the container.

11. The reciprocal pump injector of claim 10, further comprising the top end of the hollow piston rod having external threads and the cap having a coupler with internal threads, wherein the coupler is on the top surface of the cap and wherein the external threads at the top end of the piston rod engage the internal threads of the coupler and reversibly lock the handle of the hollow piston rod next to the coupler.
